(19) United States
(12) Patent Application Publication
(10) Pub. No.: US 2009/0156745 A1
(43) Pub. Date: Jun. 18, 2009

(54) SURFACE MODIFIED BIOMEDICAL DEVICES

(76) Inventors: Yu-Chin Lai, Pittsford, NY (US); Weihong Lang, Amston, CT (US)

Correspondence Address: Bausch & Lomb Incorporated, One Bausch & Lomb Place, Rochester, NY, 14604-2701, US

(21) Appl. No.: 12/329,710

(22) Filed: Dec. 8, 2008

Related U.S. Application Data
(60) Provisional application No. 61/013,777, filed on Dec. 14, 2007.

(51) Int. Cl. C08L 39/06; C08F 26/10; G02C 7/04

(52) U.S. Cl. 525/205; 526/264; 351/160 H

(57) ABSTRACT

A surface modified biomedical device is provided comprising a biomedical device having a coating on at least a portion thereof, the coating comprising one or more hydrophilic polymers having one or more non-ethylenically-unsaturated carboxylic acid terminated groups.

### BACKGROUND OF THE INVENTION

This application claims benefit of Provisional Patent No. 61/013,777 filed Dec. 14, 2007 which is incorporated by reference herein.

1. Technical Field

The present invention generally relates to surface modified biomedical devices, and especially ophthalmic devices that are intended for direct placement on or in the eye such as contact lenses or intraocular lenses and methods for their preparation.

2. Description of Related Art

Medical devices such as ophthalmic lenses made from, for example, silicone-containing materials, have been investigated for a number of years. Such materials can generally be subdivided into two major classes, namely hydrogels and non-hydrogels. Hydrogels can absorb and retain water in an equilibrium state, whereas non-hydrogels do not absorb appreciable amounts of water. Regardless of their water content, both hydrogel and non-hydrogel silicone medical devices tend to have relatively hydrophobic, non-wettable surfaces that have a high affinity for lipids. This problem is of particular concern with contact lenses.

Those skilled in the art have long recognized the need for modifying the surface of such silicone contact lenses so that they are compatible with the eye. It is known that increased hydrophilicity of the contact lens surface improves the wettability of the contact lenses. This, in turn, is associated with improved wear comfort of contact lenses. Additionally, the surface of the lens can affect the lens's susceptibility to deposition, particularly the deposition of proteins and lipids resulting from tear fluid during lens wear. Accumulated deposition can cause eye discomfort or even inflammation. In the case of extended wear lenses (i.e., lenses used without daily removal of the lens before sleep), the surface is especially important, since extended wear lenses must be designed for high standards of comfort and biocompatibility over an extended period of time.

Silicone lenses have been subjected to plasma surface treatment to improve their surface properties, e.g., surfaces have been rendered more hydrophilic, deposit resistant, scratch-resistant, or otherwise modified. Examples of previously disclosed plasma surface treatments include subjecting the surface of a contact lens to a plasma containing an inert gas or oxygen (see, for example, U.S. Pat. Nos. 4,055,378; 4,122,942; and 4,214,014); various hydrocarbon monomers (see, for example, U.S. Pat. No. 4,143,949); and combinations of oxidizing agents and hydrocarbons such as water and ethanol (see, for example, WO 95/04609 and U.S. Pat. No. 4,632,844). U.S. Pat. No. 4,312,575 discloses a process for providing a barrier coating on a silicone or polyurethane lens by subjecting the lens to an electrical glow discharge (plasma) process conducted by first subjecting the lens to a hydrocarbon atmosphere followed by subjecting the lens to oxygen during flow discharge, thereby increasing the hydrophilicity of the lens surface.

U.S. Pat. Nos. 4,168,112, 4,321,261 and 4,436,730 disclose methods for treating a charged contact lens surface with an oppositely charged ionic polymer to form a polyelectrolyte complex on the lens surface that improves wettability.

U.S. Pat. No. 4,287,175 discloses a method of wetting a contact lens that comprises inserting a water-soluble solid polymer into the cul-de-sac of the eye. The disclosed polymers include cellulose derivatives, acrylates and natural products such as gelatin, pectins and starch derivatives.

U.S. Pat. No. 5,397,848 discloses a method of incorporating hydrophilic constituents into silicone polymer materials for use in contact and intra-ocular lenses.

U.S. Pat. Nos. 5,700,559 and 5,807,636 disclose hydrophilic articles (e.g., contact lenses) comprising a substrate, an ionic polymeric layer on the substrate and a disordered polyelectrolyte coating ionically bonded to the polymeric layer.

U.S. Pat. No. 5,705,583 discloses biocompatible polymeric surface coatings. The polymeric surface coatings disclosed include coatings synthesized from monomers bearing a center of positive charge, including cationic and zwitterionic monomers.

European Patent Application No. EP 0 963 761 A1 discloses biomedical devices with coatings that are said to be stable, hydrophilic and antimicrobial, and which are formed using a coupling agent to bond a carboxyl-containing hydrophilic coating to the surface of the devices by ester or amide linkages.

U.S. Pat. No. 6,428,839 discloses a method for improving the wettability of a medical device which includes the steps of (a) providing a medical device formed from a monomer mixture comprising a hydrophilic monomer and a silicone-containing monomer; and (b) contacting a surface of the medical device with a solution including a polymer or copolymer of (meth)acrylic acid.

Accordingly, it would be desirable to provide improved biomedical devices such as a silicone hydrogel contact lens with an optically clear, hydrophilic surface film that will not only exhibit improved wettability, but which will generally allow the use of a silicone hydrogel contact lens in the human eye for an extended period of time. In the case of a silicone hydrogel lens for extended wear, it would be desirable to provide a contact lens with a surface that is also highly permeable to oxygen and water. Such a surface treated lens would be comfortable to wear in actual use and would allow for the extended wear of the lens without irritation or other adverse effects to the cornea.

### SUMMARY OF THE INVENTION

In accordance with one embodiment of the present invention, a method of making a surface modified biomedical device is provided comprising (a) providing a biomedical device; and (b) coating a surface of the biomedical device with a coating composition comprising a hydrophilic polymer having one or more non-ethylenically-unsaturated carboxylic acid terminated groups.

In accordance with a second embodiment of the present invention, a surface modified biomedical device is provided comprising a biomedical device having a surface coating comprising a hydrophilic polymer having one or more non-ethylenically-unsaturated carboxylic acid terminated groups.

In accordance with a third embodiment of the present invention, a method for improving the wettability of a biomedical device is provided comprising the step of contacting a surface of the biomedical device with a composition comprising a hydrophilic polymer having one or more non-ethylenically-unsaturated carboxylic acid terminated groups.

In accordance with a fourth embodiment of the present invention, a method for improving the wettability of a biomedical device is provided comprising the step of contacting a surface of a biomedical device formed from a monomeric mixture comprising a hydrophilic monomer and a silicone-containing monomer with a composition comprising a hydrophilic polymer having one or more non-ethylenically-unsaturated carboxylic acid terminated groups.

The surface modified biomedical devices of the present invention advantageously provide a higher level of performance quality and/or comfort to the users due to their hydrophilic or lubricious (or both) surfaces. Hydrophilic and/or lubricious surfaces of the biomedical devices herein such as contact lenses substantially prevent or limit the adsorption of tear lipids and proteins on, and their eventual absorption into, the lenses, thus preserving the clarity of the contact lenses. This, in turn, preserves their performance quality thereby providing a higher level of comfort to the wearer.

### DETAILED DESCRIPTION OF THE PREFERRED EMBODIMENTS

The present invention is directed to surface modified biomedical devices intended for direct contact with body tissue or fluid. Representative examples of biomedical devices include, but are not limited to, artificial ureters, diaphragms, intrauterine devices, heart valves, catheters, denture liners, prosthetic devices, ophthalmic lens applications, where the lens is intended for direct placement in or on the eye, such as, for example, intraocular devices and contact lenses. The devices can provide optical correction, wound care, drug delivery, diagnostic functionality or cosmetic enhancement or effect or a combination of these properties. As used herein, the term “ophthalmic device” refers to devices that reside in or on the eye. Useful ophthalmic devices include, but are not limited to, ophthalmic lenses such as soft contact lenses, e.g., a soft, hydrogel lens (e.g., silicone hydrogels), soft, non-hydrogel lens and the like; hard contact lenses, e.g., a hard, gas permeable lens material and the like; intraocular lenses; overlay lenses; ocular inserts; optical inserts and the like. As is understood by one skilled in the art, a lens is considered to be “soft” if it can be folded back upon itself without breaking. The preferred biomedical devices are ophthalmic devices, particularly contact lenses, most particularly contact lenses made from silicone hydrogels. The biomedical devices are coated with a coating composition described to improve the hydrophilicity and lipid resistance of the biomedical device by coating the surface of the biomedical device

The biomedical devices to be surface modified according to the present invention can be any material known in the art capable of forming a biomedical device as described above. In one embodiment, a biomedical device includes devices formed from material not hydrophilic per se. Such devices are formed from materials known in the art and include, by way of example, polysiloxanes, perfluoropolyethers, fluorinated poly(meth)acrylates or equivalent fluorinated polymers derived, e.g., from other polymerizable carboxylic acids, polyalkyl(meth)acrylates or equivalent alkylester polymers derived from other polymerizable carboxylic acids, or fluorinated polyolefins, such as fluorinated ethylene propylene polymers, or tetrafluoroethylene, preferably in combination with a dioxol, e.g., perfluoro-2,2-dimethyl-1,3-dioxol. Representative examples of suitable bulk materials include, but are not limited to, Lotrafilcon A, Neofocon, Pasifocon, Telefocon, Silafocon, Fluorsilfocon, Paflufocon, Silafocon, Elastofilcon, Fluorofocon or Teflon AF materials, such as Teflon AF 1600 or Teflon AF 2400 which are copolymers of about 63 to about 73 mol % of perfluoro-2,2-dimethyl-1,3-dioxol and about 37 to about 27 mol % of tetrafluoroethylene, or of about 80 to about 90 mol % of perfluoro-2,2-dimethyl-1,3-dioxol and about 20 to about 10 mol % of tetrafluoroethylene.

In another embodiment, a biomedical device includes devices formed from material hydrophilic per se, since reactive groups, e.g., carboxy, carbamoyl, sulfate, sulfonate, phosphate, amine, ammonium or hydroxy groups, are inherently present in the material and therefore also at the surface of a biomedical device manufactured therefrom. Such devices are formed from materials known in the art and include, by way of example, polyhydroxyethyl acrylate, polyhydroxyethyl methacrylate, polyvinyl pyrrolidone (PVP), polyacrylic acid, polymethacrylic acid, polyacrylamide, polydimethylacrylamide (DMA), polyvinyl alcohol and the like and copolymers thereof, e.g., from two or more monomers selected from hydroxyethyl acrylate, hydroxyethyl methacrylate, N-vinyl pyrrolidone, acrylic acid, methacrylic acid, acrylamide, dimethyl acrylamide, vinyl alcohol and the like. Representative examples of suitable bulk materials include, but are not limited to, Polymacon, Tefilcon, Methafilcon, Deltafilcon, Bufilcon, Phemfilcon, Ocufilcon, Focofilcon, Etafilcon, Hefilcon, Vifilcon, Tetrafilcon, Perfilcon, Droxifilcon, Dimefilcon, Isofilcon, Mafilcon, Nelfilcon, Atlafilcon and the like. Examples of other suitable bulk materials include balafilcon A, hilafilcon A, alphafilcon A, bilafilcon B and the like.

In another embodiment, biomedical devices to be surface modified according to the present invention include devices which are formed from material which are amphiphilic segmented copolymers containing at least one hydrophobic segment and at least one hydrophilic segment which are linked through a bond or a bridge member.

It is particularly useful to employ biocompatible materials herein including both soft and rigid materials commonly used for ophthalmic lenses, including contact lenses. In general, non-hydrogel materials are hydrophobic polymeric materials that do not contain water in their equilibrium state. Typical non-hydrogel materials comprise silicone acrylics, such as those formed bulky silicone monomer (e.g., tris(trimethylsiloxy)silylpropyl methacrylate, commonly known as “TRIS” monomer), methacrylate end-capped poly(dimethylsiloxane)prepolymer, or silicones having fluoroalkyl side groups (polysiloxanes are also commonly known as silicone polymers).

On the other hand, hydrogel materials comprise hydrated, cross-linked polymeric systems containing water in an equilibrium state. Hydrogel materials contain about 5 weight percent water or more (up to, for example, about 80 weight percent). The preferred hydrogel materials, include silicone hydrogel materials. In one preferred embodiment, materials include vinyl functionalized polydimethylsiloxanes copolymerized with hydrophilic monomers as well as fluorinated methacrylates and methacrylate functionalized fluorinated polyethylene oxides copolymerized with hydrophilic monomers. Representative examples of suitable materials for use herein include those disclosed in U.S. Pat. Nos. 5,310,779; 5,387,662; 5,449,729; 5,512,205; 5,610,252; 5,616,757; 5,708,094; 5,710,302; 5,714,557 and 5,908,906, the contents of which are incorporated by reference herein.

In one embodiment, hydrogel materials for biomedical devices, such as contact lenses, can contain a hydrophilic monomer such as one or more unsaturated carboxylic acids, vinyl lactams, amides, polymerizable amines, vinyl carbonates, vinyl carbamates, oxazolone monomers, copolymers thereof and the like and mixtures thereof. Useful amides include acrylamides such as N,N-dimethylacrylamide and N,N-dimethylmethacrylamide. Useful vinyl lactams include cyclic lactams such as N-vinyl-2-pyrrolidone. Examples of other hydrophilic monomers include hydrophilic prepolymers such as poly(alkene glycols) functionalized with polymerizable groups. Examples of useful functionalized poly(alkene glycols) include poly(diethylene glycols) of varying chain length containing monomethacrylate or dimethacrylate end caps. In a preferred embodiment, the poly(alkene glycol) polymer contains at least two alkene glycol monomeric units. Still further examples are the hydrophilic vinyl carbonate or vinyl carbamate monomers disclosed in U.S. Pat. No. 5,070,215, and the hydrophilic oxazolone monomers disclosed in U.S. Pat. No. 4,910,277. Other suitable hydrophilic monomers will be apparent to one skilled in the art. In another embodiment, a hydrogel material can contain a siloxane-containing monomer and at least one of the aforementioned hydrophilic monomers and/or prepolymers.

Non-limited examples of hydrophobic monomers are C₁-C₂₀ alkyl and C₃-C₂₀ cycloalkyl(meth)acrylates, substituted and unsubstituted aryl(meth)acrylates (wherein the aryl group comprises 6 to 36 carbon atoms), (meth)acrylonitrile, styrene, lower alkyl styrene, lower alky vinyl ethers, and C₂-C₁₀ perfluroalkyl(meth)acrylates and correspondingly partially fluorinate(meth)acrylates.

A wide variety of materials can be used herein, and silicone hydrogel contact lens materials are particularly preferred. Silicone hydrogels generally have a water content greater than about 5 weight percent and more commonly between about 10 to about 80 weight percent. Such materials are usually prepared by polymerizing a mixture containing at least one silicone-containing monomer and at least one hydrophilic monomer. Typically, either the silicone-containing monomer or the hydrophilic monomer functions as a crosslinking agent (a crosslinker being defined as a monomer having multiple polymerizable functionalities) or a separate crosslinker may be employed. Applicable silicone-containing monomers for use in the formation of silicone hydrogels are well known in the art and numerous examples are provided in U.S. Pat. Nos. 4,136,250; 4,153,641; 4,740,533; 5,034,461; 5,070,215; 5,260,000; 5,310,779; and 5,358,995.

Representative examples of applicable silicon-containing monomers include bulky polysiloxanylalkyl(meth)acrylic monomers. An example of a bulky polysiloxanylalkyl(meth)acrylic monomer is represented by the structure of Formula I:

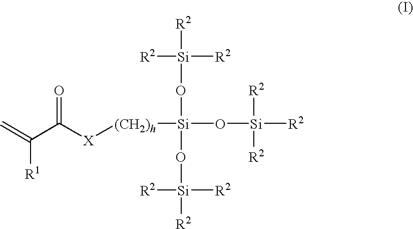

wherein X denotes or —O— or —NR— wherein R denotes hydrogen or a C₁-C₄ alkyl; each R¹ independently denotes hydrogen or methyl; each R² independently denotes a lower alkyl radical, phenyl radical or a group represented by

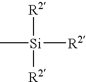

wherein each R^{2′} independently denotes a lower alkyl or phenyl radical; and h is 1 to 10.

Examples of bulky monomers are methacryloxypropyl tris(trimethyl-siloxy)silane or tris(trimethylsiloxy)silylpropyl methacrylate, sometimes referred to as TRIS and tris(trimethylsiloxy)silylpropyl vinyl carbamate, sometimes referred to as TRIS-VC and the like.

Such bulky monomers may be copolymerized with a silicone macromonomer, which is a poly(organosiloxane) capped with an unsaturated group at two or more ends of the molecule. U.S. Pat. No. 4,153,641 discloses, for example, various unsaturated groups such as acryloxy or methacryloxy groups.

Another class of representative silicone-containing monomers includes, but is not limited to, silicone-containing vinyl carbonate or vinyl carbamate monomers such as, for example, 1,3-bis[4-vinyloxycarbonyloxy)but-1-yl]tetramethyl-disiloxane; 3-(trimethylsilyl)propyl vinyl carbonate; 3-(vinyloxycarbonylthio)propyl-[tris(trimethylsiloxy)silane]; 3-[tris(trimethylsiloxy)silyl]propyl vinyl carbamate; 3-[tris(trimethylsiloxy)silyl]propyl allyl carbamate; 3-[tris(trimethylsiloxy)silyl]propyl vinyl carbonate; t-butyldimethylsiloxyethyl vinyl carbonate; trimethylsilylethyl vinyl carbonate; trimethylsilylmethyl vinyl carbonate and the like and mixtures thereof.

Another class of silicon-containing monomers includes polyurethane-polysiloxane macromonomers (also sometimes referred to as prepolymers), which may have hard-soft-hard blocks like traditional urethane elastomers. They may be end-capped with a hydrophilic monomer such as HEMA. Examples of such silicone urethanes are disclosed in a variety or publications, including Lai, Yu-Chin, “The Role of Bulky Polysiloxanylalkyl Methacryates in Polyurethane-Polysiloxane Hydrogels,” Journal of Applied Polymer Science, Vol. 60, 1193-1199 (1996). PCT Published Application No. WO 96/31792 discloses examples of such monomers, which disclosure is hereby incorporated by reference in its entirety. Further examples of silicone urethane monomers are represented by Formulae II and III:

E(*D*A*D*G)ₐ*D*A*D*E′; or (II)

E(*D*G*D*A)ₐ*D*A*D*E′; or (III)

wherein:

D independently denotes an alkyl diradical, an alkyl cycloalkyl diradical, a cycloalkyl diradical, an aryl diradical or an alkylaryl diradical having 6 to about 30 carbon atoms;

G independently denotes an alkyl diradical, a cycloalkyl diradical, an alkyl cycloalkyl diradical, an aryl diradical or an alkylaryl diradical having 1 to about 40 carbon atoms and which may contain ether, thio or amine linkages in the main chain;

* denotes a urethane or ureido linkage;

a is at least 1;

A independently denotes a divalent polymeric radical of Formula IV:

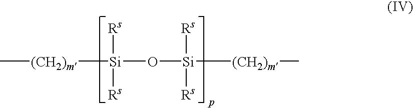

wherein each R⁵ independently denotes an alkyl or fluoro-substituted alkyl group having 1 to about 10 carbon atoms which may contain ether linkages between the carbon atoms; m′ is at least 1; and p is a number that provides a moiety weight of about 400 to about 10,000;

each of E and E′ independently denotes a polymerizable unsaturated organic radical represented by Formula V:

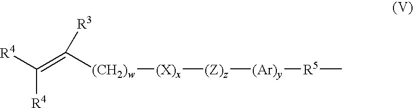

wherein: R³ is hydrogen or methyl;
R⁴ is hydrogen, an alkyl radical having 1 to 6 carbon atoms, or a —CO—Y—R⁶ radical
wherein Y is —O—, —S— or —NH—;
R⁵ is a divalent alkylene radical having 1 to about 10 carbon atoms;
R⁶ is a alkyl radical having 1 to about 12 carbon atoms;
X denotes —CO— or —OCO—;
Z denotes —O— or —NH—;
Ar denotes an aromatic radical having about 6 to about 30 carbon atoms;
w is 0 to 6; x is 0 or 1; y is 0 or 1; and z is 0 or 1.

A preferred silicone-containing urethane monomer is represented by Formula VI:

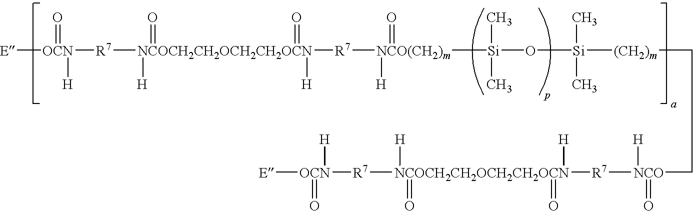

wherein m is at least 1 and is preferably 3 or 4, a is at least 1 and preferably is 1, p is a number which provides a moiety weight of about 400 to about 10,000 and is preferably at least about 30, R⁷ is a diradical of a diisocyanate after removal of the isocyanate group, such as the diradical of isophorone diisocyanate, and each E″ is a group represented by:

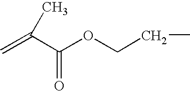

In another embodiment of the present invention, a silicone hydrogel material comprises (in bulk, that is, in the monomer mixture that is copolymerized) about 5 to about 50 percent, and preferably about 10 to about 25, by weight of one or more silicone macromonomers, about 5 to about 75 percent, and preferably about 30 to about 60 percent, by weight of one or more polysiloxanylalkyl(meth)acrylic monomers, and about 10 to about 50 percent, and preferably about 20 to about 40 percent, by weight of a hydrophilic monomer. In general, the silicone macromonomer is a poly(organosiloxane) capped with an unsaturated group at two or more ends of the molecule. In addition to the end groups in the above structural formulas, U.S. Pat. No.4,153,641 discloses additional unsaturated groups, including acryloxy or methacryloxy. Fumarate-containing materials such as those disclosed in U.S. Pat. Nos. 5,310,779; 5,449,729 and 5,512,205 are also useful substrates in accordance with the invention. The silane macromonomer may be a silicon-containing vinyl carbonate or vinyl carbamate or a polyurethane-polysiloxane having one or more hard-soft-hard blocks and end-capped with a hydrophilic monomer.

Another class of representative silicone-containing monomers includes fluorinated monomers. Such monomers have been used in the formation of fluorosilicone hydrogels to reduce the accumulation of deposits on contact lenses made therefrom, as disclosed in, for example, U.S. Pat. Nos. 4,954,587; 5,010,141 and 5,079,319. Also, the use of silicone-containing monomers having certain fluorinated side groups, i.e., —(CF₂)—H, have been found to improve compatibility between the hydrophilic and silicone-containing monomeric units. See, e.g., U.S. Pat. Nos. 5,321,108 and 5,387,662.

The above silicone materials are merely exemplary, and other materials for use as substrates that can benefit by being coated with the hydrophilic coating composition according to the present invention and have been disclosed in various publications and are being continuously developed for use in contact lenses and other medical devices can also be used. For example, a biomedical device can be formed from at least a cationic monomer such as cationic silicone-containing monomer or cationic fluorinated silicone-containing monomers.

Contact lenses for application of the present invention can be manufactured employing various conventional techniques, to yield a shaped article having the desired posterior and anterior lens surfaces. Spincasting methods are disclosed in U.S. Pat. Nos. 3,408,429 and 3,660,545; and static casting methods are disclosed in U.S. Pat. Nos. 4,113,224, 4,197,266 and 5,271,876. Curing of the monomeric mixture may be followed by a machining operation in order to provide a contact lens having a desired final configuration. As an example, U.S. Pat. No. 4,555,732 discloses a process in which an excess of a monomeric mixture is cured by spincasting in a mold to form a shaped article having an anterior lens surface and a relatively large thickness. The posterior surface of the cured spincast article is subsequently lathe cut to provide a contact lens having the desired thickness and posterior lens surface. Further machining operations may follow the lathe cutting of the lens surface, for example, edge-finishing operations.

Typically, an organic diluent is included in the initial monomeric mixture in order to minimize phase separation of polymerized products produced by polymerization of the monomeric mixture and to lower the glass transition temperature of the reacting polymeric mixture, which allows for a more efficient curing process and ultimately results in a more uniformly polymerized product. Sufficient uniformity of the initial monomeric mixture and the polymerized product is of particular importance for silicone hydrogels, primarily due to the inclusion of silicone-containing monomers which may tend to separate from the hydrophilic comonomer.

Suitable organic diluents include, for example, monohydric alcohols such as C₆-C₁₀ straight-chained aliphatic monohydric alcohols, e.g., n-hexanol and n-nonanol; diols such as ethylene glycol; polyols such as glycerin; ethers such as diethylene glycol monoethyl ether; ketones such as methyl ethyl ketone; esters such as methyl enanthate; and hydrocarbons such as toluene. Preferably, the organic diluent is sufficiently volatile to facilitate its removal from a cured article by evaporation at or near ambient pressure.

Generally, the diluent may be included at about 5 to about 60 percent by weight of the monomeric mixture, with about 10 to about 50 percent by weight being especially preferred. If necessary, the cured lens may be subjected to solvent removal, which can be accomplished by evaporation at or near ambient pressure or under vacuum. An elevated temperature can be employed to shorten the time necessary to evaporate the diluent.

Following removal of the organic diluent, the lens can then be subjected to mold release and optional machining operations. The machining step includes, for example, buffing or polishing a lens edge and/or surface. Generally, such machining processes may be performed before or after the article is released from a mold part. As an example, the lens may be dry released from the mold by employing vacuum tweezers to lift the lens from the mold.

As one skilled in the art will readily appreciate, biomedical device surface functional groups of the biomedical device according to the present invention may be inherently present at the surface of the device. However, if the biomedical device contains too few or no functional groups, the surface of the device can be modified by known techniques, for example, plasma chemical methods (see, for example, WO 94/06485), or conventional functionalization with groups such as —OH, —NH₂ or —CO₂H. Suitable biomedical device surface functional groups of the biomedical device include a wide variety of groups well known to the skilled artisan. Representative examples of such functional groups include, but are not limited to, hydroxy groups, amino groups, carboxy groups, carbonyl groups, aldehyde groups, sulfonic acid groups, sulfonyl chloride groups, isocyanato groups, carboxy anhydride groups, lactone groups, azlactone groups, epoxy groups and groups being replaceable by amino or hydroxy groups, such as halo groups, or mixtures thereof. In one embodiment, the biomedical device surface functional groups of the biomedical device are amino groups and/or hydroxy groups.

The foregoing biomedical devices are then contacted with a coating composition containing at least a hydrophilic polymer having one or more non-ethylenically-unsaturated carboxylic acid terminated groups. The devices may either be unhydrated or prehydrated in water or an aqueous solution. The hydrophilic polymers can have a weight average molecular weight ranging from about 1,000 to about 1,000,000 and preferably from about 5,000 to about 100,000.

One class of a hydrophilic polymer having one or more non-ethylenically-unsaturated carboxylic acid terminated groups can be of the general formula:

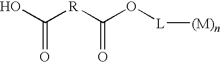

wherein R is a residue of a non-ethylenically-unsaturated carboxylic acid group-forming monomer, e.g., a saturated anhydride as discussed below, L is a linking group such as a direct bond or a divalent linkage group that includes a hydrocarbon group or a heterohydrocarbon group containing one or more atoms selected from the group consisting of O, N, S, and combinations thereof; M is an oligomer or polymer having a plurality of hydrophilic groups and n is an integer from 5 to about 10,000 and preferably about 50 to about 1,000. Representative examples of suitable L groups include an unsaturated or saturated, unsubstituted or substituted C₁-C₁₀ branched hydrocarbon group optionally containing one or more heteroatoms, an unsaturated or saturated, unsubstituted or substituted C₃-C₁₀ linear hydrocarbon group optionally containing one or more heteroatoms, an unsaturated or saturated, unsubstituted or substituted C₃-C₂₅ cyclic hydrocarbon group optionally containing one or more heteroatoms and the like.

Another class of a hydrophilic polymer having one or more non-ethylenically-unsaturated carboxylic acid terminated groups can be of the general formula:

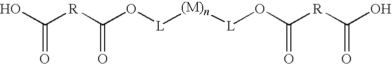

wherein R, L, M and n independently have the aforestated meanings.

The hydrophilic polymer having one or more non-ethylenically-unsaturated carboxylic acid terminated groups can be obtained by reacting a hydroxyl-terminated oligomer or polymer having a plurality of hydrophilic groups with a non-ethylenically-unsaturated carboxylic acid group-forming monomer such as a saturated cyclic anhydride under conditions effective to produce the hydrophilic polymer having one or more non-ethylenically-unsaturated carboxylic acid terminated groups. In one embodiment, the hydroxyl-terminated oligomer or polymer is a monohydroxyl-terminated oligomer or polymer. In another embodiment, the hydroxyl-terminated oligomer or polymer is a diterminal hydroxyl-terminated oligomer or polymer, i.e., the oligomer or polymer is terminated on each end with a hydroxyl-containing terminal group.

The oligomeric or polymeric chain comprises units derived from N-vinylpyrrolidone. In another embodiment, the oligomeric or polymeric chain comprises units are derived from mono- or polyhydric alcohols, e.g., glyceryl methacrylate, glyceryl acrylate, HEMA, erythritol(meth)acrylate, xylitol(meth)acrylate, sorbitol (meth)acrylate, and the like, acrylamides, e.g., dimethyl methacrylamide, DMA and the like, copolymers thereof and derivatives thereof. The oligomeric or polymeric chain can also comprises units derived from one of the foregoing monomers of an alkylene oxide (such as ethylene oxide).

The hydroxyl-terminated hydrophilic polymer can be synthesized by, for example, (a) mixing one or more oligomeric or polymeric chain-forming monomers or polymers with a hydroxyl-containing monomer; (b) adding a polymerization initiator; and (c) subjecting the monomer/initiator mixture to thermal energy or a source of ultraviolet or other light and curing the mixture. The mixture preferably contains at least one hydroxyl-containing monomer so that the polymer formed is hydroxyl-terminated. Useful hydroxyl-containing monomers include, by way of example, 2-isopropoxyethanol, allyl alcohol and the like.

Polymerization initiators include free-radical-generating polymerization initiators and ultraviolet (UV) free-radical initiators. Representative free radical thermal polymerization initiators are usually peroxides or azo initiators such as, for example, acetal peroxide, lauroyl peroxide, decanoyl peroxide, stearoyl peroxide, benzoyl peroxide, tertiarylbutyl peroxypivalate, peroxydicarbonate, 2,2′-azo-bis(2-methylpropionitrile), benzoin methyl ether and the like and mixtures thereof. Representative UV initiators are those known in the field such as, for example, benzoin methyl ether, benzoin ethyl ether, Darocure 1173, 1164, 2273, 1116, 2959, 3331 (EM Industries) and Igracure 651 and 184 (Ciba-Geigy), and the like and mixtures thereof. Other polymerization initiators which may be used are disclosed in, for example, “Polymer Handbook”, 4th edition, Ed. J. Brandrup, E. H. Immergut, E. A. Grulke, A. Abe and D. R. Bloch, Pub. Wiley-Interscience, New York, 1998. The curing process will of course depend upon the initiator used and the physical characteristics of the comonomer mixture such as viscosity. In any event, the level of initiator employed may vary within the range of about 0.01 to about 2 weight percent of the mixture of monomers.

Polymerization of the mixture to form the hydroxyl-terminated hydrophilic polymer can be carried out in the presence of a solvent. Suitable solvents are in principle all solvents which dissolve the reactants such as, for example, water, alcohols such as lower alkanols, e.g., methanol, methanol and the like; carboxamides such as dimethylformamide and the like; dipolar aprotic solvents such as dimethyl sulfoxide and the like; ketones such as acetone, methyl ethyl ketone, cyclohexanone, and the like; aliphatic or aromatic hydrocarbons such as toluene, xylene, n-hexane and the like; ethers such as tetrahydrofuran, dimethoxyethane, dioxane and the like; halogenated hydrocarbons such as trichloroethane and the like, and also mixtures of suitable solvents, for example mixtures of water and an alcohol, e.g., a water/methanol or water/ethanol mixture, and the like.

Suitable saturated anhydrides are saturated, cyclic anhydrides. Preferably, the anhydride ring incorporates from two to four methylene or substituted methylene groups. Representative examples of such saturated, cyclic anhydrides include succinic anhydride, glutaric anhydride, adipic anhydride, methylsuccinic anhydride, 2-phenylglutaric anhydride, 3-methylglutaric anhydride, 3-methyladipic anhydride, and the like, and mixtures thereof.

The hydrophilic polymer having one or more non-ethylenically-unsaturated carboxylic acid terminated groups can be obtained by, for example, (a) reacting a hydroxyl-terminated oligomer or polymer having a plurality of hydrophilic groups with a non-ethylenically-unsaturated carboxylic acid group-forming monomer optionally in the presence of a polymerization initiator and (b) subjecting the monomer/initiator mixture to thermal energy or a source of ultraviolet or other light and curing the mixture. Polymerization initiators which may be used include the free-radical-generating polymerization initiators and UV free-radical initiators discussed above. The curing process will of course depend upon the initiator used and the physical characteristics of the comonomer mixture such as viscosity. In any event, the level of initiator employed may vary within the range of about 0.01 to about 2 weight percent of the mixture of monomers.

The relative amounts of hydroxyl-terminated hydrophilic polymer and the saturated, cyclic anhydride can vary over a fairly broad range. The amounts can be chosen to provide a polymer having the molecular weights discussed above. Generally, the anhydride:hydroxyl-terminated hydrophilic polymer ratio is about 2:1.

Polymerization of the mixture to form the hydrophilic polymer can be carried out in the presence of a solvent. Suitable solvents are in principle all solvents which can dissolve the reactants such as, for example, water, alcohols such as lower alkanols, e.g., methanol, methanol and the like; carboxamides such as dimethylformamide and the like; dipolar aprotic solvents such as dimethyl sulfoxide and the like; ketones such as acetone, methyl ethyl ketone, cyclohexanone and the like; aliphatic or aromatic hydrocarbons such as toluene, xylene, n-hexane and the like; ethers such as tetrahydrofuran, dimethoxyethane, dioxane and the like; halogenated hydrocarbons such as trichloroethane and the like, and mixtures thereof, e.g., mixtures of water and an alcohol, e.g., a water/methanol or water/ethanol mixture, and the like.

The coating can be formed on the biomedical device by conventional techniques, for example, immersion, dip coating, spray coating, electrostatic coating and the like. For example, in one embodiment, a surface of a biomedical device can be contacted with a coating composition of this invention containing a hydrophilic polymer or copolymer having non-ethylenically-unsaturated carboxylic acid terminated groups at about room temperature or under autoclave conditions. In this embodiment, the biomedical device is immersed in the coating solution for a time period sufficient to form a coating on the surface of the biomedical device. The coating solution can be an aqueous solution. Alternatively, the coating solution can contain a polar organic solvent, such as methanol or ethanol.

If desired, the coating solution can contain a linking compound (or linking polymer). Useful linking compounds have a first linking-compound functional group that is capable of interacting with biomedical-device surface functional groups, and a second linking-compound functional group that is capable of interacting with the coating hydrophilic polymer. Accordingly, in one aspect, the biomedical device is contacted with the linking compound and the coating hydrophilic polymer substantially simultaneously. In another aspect, the biomedical device is first immersed in a solution containing the linking compound and then, after some elapsed time, the coating hydrophilic polymer is added to the solution in which the biomedical device is still immersed.

The hydrophilic polymer having one or more non-ethylenically-unsaturated carboxylic acid terminated groups can be retained on the surface of the biomedical device through an interaction of the hydrophilic polymer and biomedical-device surface functional groups. For example, the hydrophilic polymer may have chemical binding interactions between the biomedical-device surface functional groups and the hydrophilic polymer. Generally, the chemical binding interactions include, but are not limited to, ionic chemical interactions, covalent interactions, hydrogen-bond interactions, hydrophobic interactions, and hydrophilic interactions. Hydrogen-bonding interactions may involve hydrogen-bond donating groups or hydrogen bond accepting groups located on the surface of a biomedical device or as a chemical functional group moiety attached to the hydrophilic polymer(s) material. Alternatively, such an interaction can involve complexation between the hydrophilic polymer and the biomedical-device surface functional groups.

In another embodiment, a method of the present invention includes: (1) molding an ophthalmic lens in a mold comprising a posterior and anterior mold portion, (2) removing the lens from the mold, and (3) introducing the lens and the solution with the carboxylic acid-terminated hydrophilic polymer into a container.

The surface modified biomedical devices such as contact lenses obtained herein may be subjected to optional machining operations. Examples of optional machining steps include buffing or polishing a lens edge and/or surface. Generally, such machining processes may be performed before or after the product is released from a mold part, e.g., the lens is dry released from the mold by employing vacuum tweezers to lift the lens from the mold, after which the lens is transferred by means of mechanical tweezers to a second set of vacuum tweezers and placed against a rotating surface to smooth the surface or edges. The lens may then be turned over in order to machine the other side of the lens.

As one skilled in the art will readily appreciate, other steps may be included in the method described above. Such other steps can include, for example, coating the formed lens, further surface treatment of the surface modified lens, inspecting the lens, discarding defective lenses and the like and combinations thereof.

The following examples are provided to enable one skilled in the art to practice the invention and are merely illustrative of the invention. The examples should not be read as limiting the scope of the invention as defined in the claims.

In the examples, the following abbreviations are used.
I4D5S4H: A prepolymer derived from 10 moles of isophorone diisocyanate, 4 moles of diethyleneglycol, 5 moles of hydroxybutyl-terminated polydimethylsiloxane of Mn 4000 and end-capped with 2-hydroxyethyl methacrylate

TRIS: tris(trimethylsiloxy)silylpropyl methacrylate

NVP: N-vinyl-2-pyrrolidone

PVP: poly(vinylpyrrolidone)

DMA: N,N-dimethyl acrylamide

HEMA: 2-hydroxyethyl methacrylate

HEMAVC: methacryloxyethyl vinyl carbonate

D1173: 2-hydroxy-2-methyl-1-phenylpropan-1-one (available as Darocur 1173 initiator)

IMVT: 1,4-bis(4-(2-methacryloxyethyl)phenylamino)anthraquinone

PP: polypropylene

DI: de-ionized

IPA: isopropyl alcohol

AIBN: Vazo™ 64(azo bis-isobutylnitrile

THIF: tetrahydrofuran

### EXAMPLE 1

Preparation of hydroxyl functionalized poly(vinyl pyrrolidone)

To a 2-liter three-neck flask equipped with a condenser and nitrogen inlet tube was added 900 ml of 2-isopropoxyethanol (about 813.6 g, 7.812 mol, Aldrich Chemical Company), 30 mol of freshly distilled NVP (about 31.35 g, 0.282 mol) and AIBN (0.317 g; 1.930 mmol). The contents were bubbled vigorously with nitrogen for 1 hour. Then, while under nitrogen blanket, the contents were heated at 80° C. for two days. The solution was ultra filtrated using a 1000 NMWL RC film. Next, the solvent was removed using a rotavapor at 50 to 60 rpms. THF (100 ml) was added to dissolve the product and then tin 2000 mL ether was poured to precipitate the product. The product was dried in a vacuum oven to give 30.85 g of product. The hydroxyl functionalized PVP had a number average molecular weight (Mₙ) of 1357 as determined by titration.

### EXAMPLE 2

Preparation of acid-terminated PVP

To a thoroughly dried 500-mL round bottom flask equipped with nitrogen inlet tube and drying tube, is charged 200 mL of anhydrous THF. Next, succinic anhydride (2.00 g, 0.02 mole) and the hydroxyl functionalized poly(vinyl pyrrolidone) (13.57 g, 0.010 mole) of Example 1 are added to the flask. The contents are heated under reflux for 48 hours with stirring. The solution is concentrated to 100 mL and is poured into 2000 mL of ether to precipitate the product.

### EXAMPLE 3

Preparation of poly(vinyl pyrrolidone-co-allyl alcohol)

To a 1000 ml three-neck flask equipped with a condenser and nitrogen inlet tube was added 250 mL of distilled water, 45.51 g (409.5 mmole) of freshly distilled NVP, 1,1725 g (20.19 mmole) of allyl alcohol and AIBN (0.47 g; 2.862 mmol). The contents were bubbled vigorously with nitrogen for 1 hour. While under nitrogen blanket and with stirring, the contents were heated up to 70° C. for two days. The solution became viscous even after one hour of heating. After two days, the product was recovered by freeze drying. The product had a Mn of 1,020,00, a Mw of 1,355,000 and a polydispersity of 1.327, as determined by Size Exclusion Chromatography. It was found that there was 1 allyl alcohol per 100 vinylpyrrolidone units.

### EXAMPLE 4

Preparation of acid-terminated PVP

To a thoroughly dried 2-L round bottom flask equipped with nitrogen inlet tube and drying tube, is charged with 30 g of product from Example 3 and 300 ml of anhydrous THF 200. The solution is refluxed until full solution. Then succinic anhydride (0.9 g, 0.009 mole) is added to the flask. The contents are heated under reflux for 48 hours with stirring. Next, the solution is concentrated to 100 mL and is poured into 2 liter ether to precipitate the product.

### EXAMPLE 5

Preparation of a polyurethane-siloxane hydrogel lens

A monomer mix was made by mixing the following components listed in Table 1, at amounts per weight.

TABLE 1

| Ingredient | Amount |
|---|---|
| I4D5S4H | 53 |
| TRIS | 15 |
| DMA | 9 |
| NVP | 24 |
| HEMA | 5 |
| HEMAVC | 1 |
| Hexanol | 10 |
| Darocur-1173 | 0.5 |
| IMVT | 150 ppm |

Lenses were cast using polypropylene molds, both in an open air bench top and in a dry box filled with nitrogen, and then cured in an oven at under the following thermal conditions: held at room temperature for 12 minutes, then ramped up to 100° C. in 54 minutes, and further held at 100° C. for 2 hours. After casting, the lenses were released from the molds and extracted in isopropanol (IPA) for 2 hours. The lenses were rinsed with distilled water and then placed in borate buffered saline. Some of these lenses were autoclaved for one cycle.

### EXAMPLE 6

Surface treatment with acid-terminated PVP

A borate buffered saline solution containing 3% of the acid-terminated PVP of Example 2 is prepared. The lenses of Example 5 are placed in glass vials containing this solution and autoclaved for 1 cycle.

### EXAMPLE 7

Surface treatment with acid-terminated PVP

A borate buffered saline solution containing 3% of the acid-terminated PVP of Example 4 is prepared. The lenses of Examples 5 are placed in glass vials containing the solution and autoclaved for 1 cycle.

It will be understood that various modifications may be made to the embodiments disclosed herein. Therefore the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the features and advantages appended hereto.

What is claimed is:

1. A method for improving the wettability of a biomedical device, the method comprising the step of contacting a surface of the biomedical device with a composition comprising one or more hydrophilic polymers having one or more non-ethylenically-unsaturated carboxylic acid terminated groups.

2. The method of claim 1, wherein the biomedical device is a contact lens.

3. The method of claim 1, wherein the biomedical device is a silicone hydrogel contact lens.

4. The method of claim 1, wherein the hydrophilic polymer comprises one or more units derived from N-vinylpyrrolidone.

5. The method of claim 1, wherein the hydrophilic polymer comprises one or more units derived from N-vinylpyrrolidone, alkylene oxides, glyceryl methacrylate, glyceryl acrylate, dimethyl methacrylamide, dimethyl acrylamide, 2-hydroxyethyl methacrylate, 2-hydroxyethyl acrylate, erythritol methacrylate, erythritol acrylate, xylitol methacrylate, xylitol acrylate, sorbitol methacrylate, sorbitol acrylate, derivatives thereof or mixtures thereof.

6. The method of claim 1, wherein the hydrophilic polymer is a reaction product of a hydroxyl-terminated oligomer or polymer having a plurality of hydrophilic groups with a saturated, cyclic anhydride.

7. The method of claim 5, wherein the hydroxyl-terminated oligomer or polymer comprises one or more units derived from N-vinylpyrrolidone.

8. The method of claim 5, wherein the saturated, cyclic anhydride is selected from the group consisting of succinic anhydride, glutaric anhydride and adipic anhydride.

9. The method of claim 1, wherein the hydrophilic polymer has one non-ethylenically-unsaturated carboxylic acid terminated group.

10. The method of claim 1, wherein the hydrophilic polymer is terminated on each end with a non-ethylenically-unsaturated carboxylic acid terminal group.

11. A surface modified biomedical device comprising a biomedical device having a coating on a surface thereof, the coating comprising one or more hydrophilic polymers having one or more non-ethylenically-unsaturated carboxylic acid terminated groups.

12. The surface modified biomedical device of claim 11, wherein the biomedical device is a contact lens.

13. The surface modified biomedical device of claim 11, wherein the biomedical device is a silicone hydrogel contact lens.

14. The surface modified biomedical device of claim 11, wherein the hydrophilic polymer comprises one or more units derived from N-vinylpyrrolidone.

15. The surface modified biomedical device of claim 11, wherein the hydrophilic polymer comprises one or more units derived from N-vinylpyrrolidone, alkylene oxides, glyceryl methacrylate, glyceryl acrylate, dimethyl methacrylamide, dimethyl acrylamide, 2-hydroxyethyl methacrylate, 2-hydroxyethyl acrylate, erythritol methacrylate, erythritol acrylate, xylitol methacrylate, xylitol acrylate, sorbitol methacrylate, sorbitol acrylate, derivatives thereof or mixtures thereof.

16. The surface modified biomedical device of claim 11, wherein the hydrophilic polymer is a reaction product of a hydroxyl-terminated oligomer or polymer having a plurality of hydrophilic groups with a saturated, cyclic anhydride.

17. The surface modified biomedical device of claim 16, wherein the hydroxyl-terminated oligomer or polymer comprises one or more units of N-vinylpyrrolidone.

18. The surface modified biomedical device of claim 16, wherein the saturated, cyclic anhydride is selected from the group consisting of succinic anhydride, glutaric anhydride and adipic anhydride.

19. The surface modified biomedical device of claim 11, wherein the hydrophilic polymer has one non-ethylenically-unsaturated carboxylic acid terminated group.

20. The surface modified biomedical device of claim 11, wherein the hydrophilic polymer is terminated on each end with a non-ethylenically-unsaturated carboxylic acid terminal group.

21. A method of forming a surface modified biomedical device, the method comprising contacting a surface of a biomedical device with a composition comprising one or more hydrophilic polymers having one or more non-ethylenically-unsaturated carboxylic acid terminated groups.

22. The method of claim 21, wherein the biomedical device is a contact lens.

23. The method of claim 21, wherein the hydrophilic polymer comprises one or more units derived from N-vinylpyrrolidone.

24. The method of claim 21, wherein the hydrophilic polymer comprises one or more derived from N-vinylpyrrolidone, alkylene oxides, glyceryl methacrylate, glyceryl acrylate, dimethyl methacrylamide, dimethyl acrylamide, 2-hydroxyethyl methacrylate, 2-hydroxyethyl acrylate, erythritol methacrylate, erythritol acrylate, xylitol methacrylate, xylitol acrylate, sorbitol methacrylate, sorbitol acrylate, derivatives thereof or mixtures thereof.

25. The method of claim 21, wherein the hydrophilic polymer is a reaction product of a hydroxyl-terminated oligomer or polymer having a plurality of hydrophilic groups with a saturated, cyclic anhydride.
